(19) United States
(12) Patent Application Publication
(10) Pub. No.: US 2024/0273559 A1
(43) Pub. Date: Aug. 15, 2024

(54) DEMAND FORECAST DEVICE, DEMAND FORECAST METHOD, AND STORAGE MEDIUM STORING DEMAND FORECAST PROGRAM

(71) Applicant: NIPPON TELEGRAPH AND TELEPHONE CORPORATION, Tokyo (JP)

(72) Inventors: Noriko YOKOYAMA, Tokyo (JP); Jun ITO, Tokyo (JP); Chihiro YAMAMOTO, Tokyo (JP); Kazuaki OBANA, Tokyo (JP)

(73) Assignee: NIPPON TELEGRAPH AND TELEPHONE CORPORATION, Tokyo (JP)

(21) Appl. No.: 18/567,762

(22) PCT Filed: Jun. 16, 2021
(86) PCT No.: PCT/JP2021/022938

§ 371 Date: Dec. 6, 2023

(51) Int. Cl. G06Q 30/0202

(52) U.S. Cl. CPC G06Q 30/0202

(57) ABSTRACT

A demand prediction device predicts the number of visits based on a number-of-visits prediction model used to predict the number of visits and factor information regarding a factor influencing the number of sales, predicts a ratio based on a ratio prediction model used to predict a ratio of the number of sales to the number of visits, and the factor information and predicts the number of sales of the commodity based on the predicted number of visits and the predicted ratio.

### TECHNICAL FIELD

A technology of the disclosure relates to a demand prediction device, a demand prediction method, and a demand prediction program.

### BACKGROUND ART

Demand prediction technologies for predicting the number of visits to shops such as restaurants are known.

For example, as a demand prediction technology, NPT 1 discloses a technology for combining environment information such as point of sale (POS) data, the weather, and event data regarding external environments in the vicinities of stores and predicting the number of visits to the stores.

### CITATION LIST

### Non Patent Literature

[NPT 1] Takashi Tanizaki, Yuta Hanayama, Takeshi Shimmura “Forecasting Customers Visiting Using Machine Learning and Characteristics Analysis with Low Forecasting Accuracy Days,” APMS 2020: Advances in Production Management Systems. Towards Smart and Digital Manufacturing pp 670-678, 25 Aug. 2020.

### SUMMARY OF INVENTION

### Technical Problem

A problem of the technology described in NPT 1 is that the number of sales of a commodity in a store, that is, a demand of each commodity cannot be predicted.

The technology of the disclosure has been made in view of the foregoing circumstances, and an object of the disclosure is to provide a demand prediction device, a demand prediction method, and a demand prediction program capable of predicting the number of sales of a commodity in a store.

### Solution to Problem

According to a first aspect of the present disclosure, a demand prediction device includes an acquisition unit configured to acquire factor information regarding a factor influencing the number of sales of a commodity in a store; a visit prediction unit configured to predict the number of visits to the store for a prediction target period based on a number-of-visits prediction model used to predict the number of visits to the store for the prediction target period and learned based on the factor information and number-of-visits information regarding a past number of visits to the store and the factor information acquired by the acquisition unit; a ratio prediction unit configured to predict a ratio of the number of sales of a commodity to the number of visits based on a ratio prediction model used to predict the ratio and learned based on the past factor information and the ratio, and the factor information acquired by the acquisition unit; and a sales prediction unit configured to predict the number of sales of a commodity based on the number of visits predicted by the visit prediction unit and the ratio predicted by the ratio prediction unit.

According to a second aspect of the present disclosure, a demand prediction method includes: acquiring, by an acquisition unit, factor information regarding a factor influencing the number of sales of a commodity in a store; predicting, by a visit prediction unit, the number of visits to the store for a prediction target period based on a number-of-visits prediction model used to predict the number of visits to the store for the prediction target period and learned based on the factor information and number-of-visits information regarding a past number of visits to the store and the factor information acquired by the acquisition unit; predicting, by a ratio prediction unit, a ratio of the number of sales of a commodity to the number of visits based on a ratio prediction model used to predict the ratio and learned based on the past factor information and the ratio, and the factor information acquired by the acquisition unit; and predicting, by a sales prediction unit, the number of sales of a commodity based on the number of visits predicted by the visit prediction unit and the ratio predicted by the ratio prediction unit.

According to a third aspect of the present disclosure, a program which is a demand prediction program causes a computer to function as each unit of the demand prediction device according to the first aspect.

### Advantageous Effects of Invention

According to the technology of the disclosure, it is possible to predict the number of sales of a commodity in a store.

### BRIEF DESCRIPTION OF DRAWINGS

FIG. 1 is a schematic diagram illustrating an example of a hardware configuration of a demand prediction device according to an embodiment.

FIG. 2 is a block diagram illustrating an example of a functional configuration of the demand prediction device according to the embodiment.

FIG. 3 is a schematic diagram illustrating an example of a commodity table according to the embodiment.

FIG. 4 is a schematic diagram illustrating an example of a configuration of the number-of-visits database according to the embodiment.

FIG. 5 is a schematic diagram illustrating an example of a configuration of an environment database according to the embodiment.

FIG. 6 is a schematic diagram illustrating an example of a configuration of a number-of-sales database according to the embodiment.

FIG. 7 is a schematic diagram illustrating an example of a configuration of a feature database according to the embodiment.

FIG. 8 is a schematic diagram illustrating an example of a configuration of a popularity database according to the embodiment.

FIG. 9 is a schematic diagram illustrating an example of a configuration of a a popularity factor database according to the embodiment.

FIG. 10 is a flowchart illustrating an example of demand learning processing in the demand prediction device according to the embodiment.

FIG. 11 is a flowchart illustrating an example of the demand learning processing in the demand prediction device according to the embodiment.

### DESCRIPTION OF EMBODIMENTS

Hereinafter, examples of embodiments of the technology of the disclosure will be described with reference to the drawings. In each drawing, the same or equivalent constituents and portions are denoted by the same reference numerals. Dimensional rates in the drawings are exaggerated for convenience of description and may differ from actual rates.

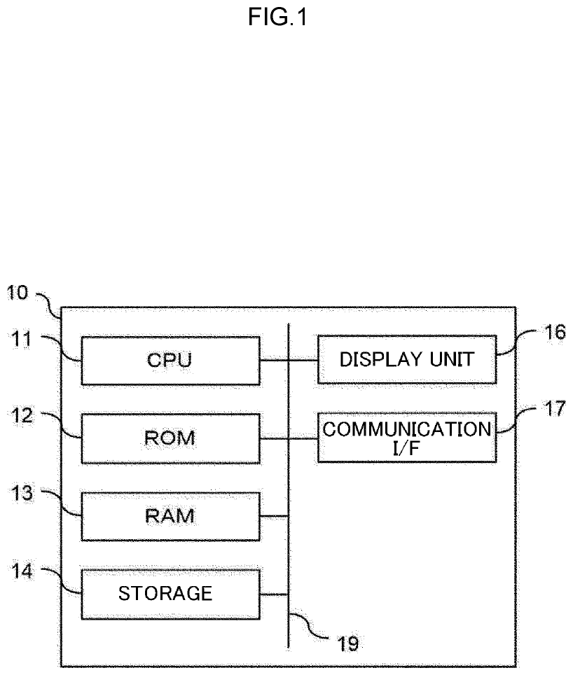

As illustrated in FIG. 1, a demand prediction device 10 includes a central processing unit (CPU) 11, a read-only memory (ROM) 12, a random access memory (RAM) 13, a storage 14, a display unit 16, and a communication interface (I/F) 17. The constituents are connected to be able to communication with each other via a bus 19.

The CPU 11 is a central processing unit and executes various programs or controls each unit. That is, the CPU 11 reads a program from the ROM 12 or the storage 14 and executes the program using the RAM 13 as a work area. The CPU 11 executes control of each configuration and various types of calculation processing according to programs stored in the ROM 12 or the storage 14. In the embodiment, a demand learning program and a demand prediction program are stored in the ROM 12 or the storage 14. The demand learning program and the demand prediction program may be a single program or a program group formed by a plurality of programs or modules.

The ROM 12 stores various programs and various types of data. The RAM 13 temporarily stores programs or data as a work area. The storage 14 is configured with a storage device such as a hard disk drive (HDD) or a solid-state drive (SSD) and stores various programs including an operating system and various types of data.

The display unit 16 is, for example, a liquid crystal display and displays the number of sales of a commodity predicted through demand prediction processing to be described below. The display unit 16 may also function as an input unit by employing a touch panel scheme.

The communication I/F 17 is an interface that communicates with other devices. For example, standards such as Ethernet (registered trademark), FDDI, and Wi-Fi (registered trademark) are used.

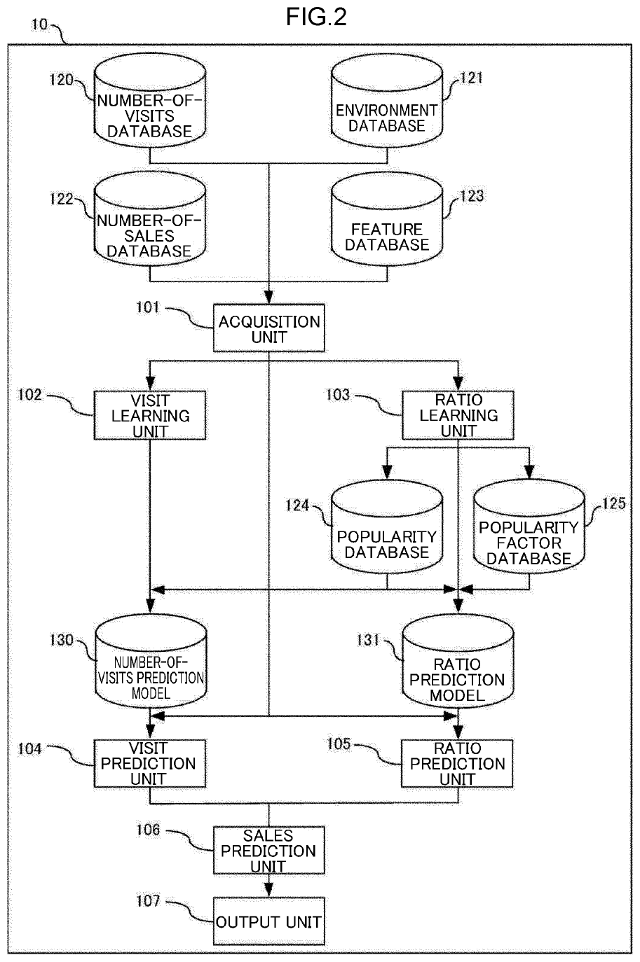

Next, a functional configuration of the demand prediction device 10 will be described. As illustrated in FIG. 2, the demand prediction device 10 includes an acquisition unit 101, a visit learning unit 102, a ratio learning unit 103, a visit prediction unit 104, a ratio prediction unit 105, a sales prediction unit 106, and an output unit 107. Further, the demand prediction device 10 includes a number-of-visits database 120, an environment database 121, a number-of-sales database 122, a feature database 123, a popularity database 124, and a popularity factor database 125.

In the present embodiment, a case in which a prediction target period which is a target period in which the number of sales of each commodity is predicted, is set as a prediction unit one day which is that day, and the number of sales is predicted for each commodity in the prediction target period will be described. The number of sales for each classification (category) to which each commodity belongs in the prediction target period may be predicted.

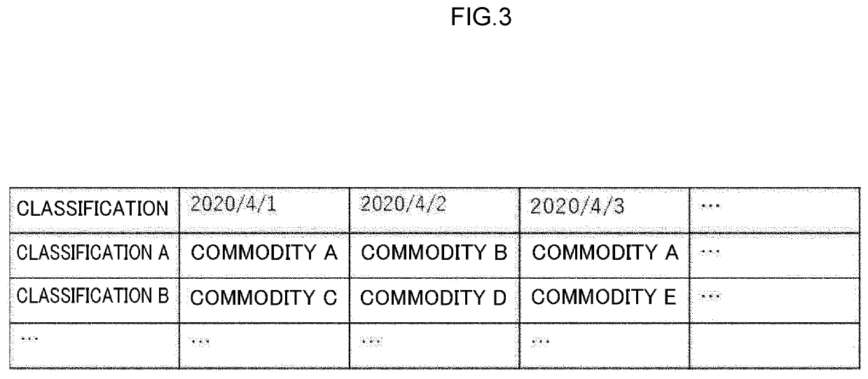

In the embodiment, a case in which commodities of a plurality of classifications are sold on a day as in the commodity table illustrated in FIG. 3, and the number of commodities corresponding to one classification is one will be described. The number of commodities corresponding to one classification may be plural. The prediction target period is not limited to that day and may be a day after the next day. A length of the prediction target period is not limited to one day and may be one hour unit, one week unit, or the like. In the embodiment, a menu provided as commodities in a restaurant is assumed, but the present invention is not limited thereto.

The acquisition unit 101 acquires number-of-visits information regarding a past number of visits to the store, factor information regarding a factor influencing the number of sales of a commodity in the store, and number-of-sales information regarding the past number of sales of the commodity. The factor information includes, for example, environmental information regarding an external environment around the store and feature information regarding a feature of the commodity. In the following description, the case in which both the environment information and the feature information are used as the factor information will be described, but any one of the environment information and the feature information may be used.

Specifically, the acquisition unit 101 acquires, as number-of-visits information in learning, the number of visits to the store during a first period which has the same length (here, one day) as a length of the prediction target period and the number of visits to the store until the previous day of the first period from the number-of-visits database 120 for each of the plurality of first periods. The acquisition unit 101 may acquire the number of visits on the previous day of the first period as the number of visits to the store until the previous day of the first period. In place of the number of visits on the previous day of the first period, the acquisition unit 101 may acquire the number of visits on each day from a predetermined number of days to the previous day of the first period (for example, one week before), an average number of visits per day until the previous day which is obtained by averaging the number of visits on each day, a cumulative number of visits or the like from a predetermined number of days to the previous day.

The acquisition unit 101 acquires the number of visits to the previous day of the prediction target period (here, that day) from the number-of-visits database 120 as the number-of-visits information in prediction. The number of visits until the previous day of the prediction target period is the same as the number of visits to the previous day of the first period.

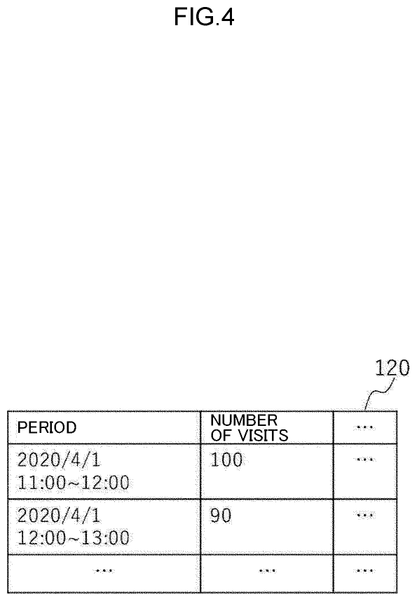

As illustrated in FIG. 4, the number-of-visits database 120 is a database in which the number of visits to the store for each predetermined period is stored. In the store number-of-visits database 120 illustrated in FIG. 4, the past number of visits to the store per hour is stored.

The past number of visits to the store per day may be stored in the number-of-visits database 120. As in the example of FIG. 4, when the number of visits per hour is stored and the length of the prediction target period and the first period is one day, the acquisition unit 101 may acquire, as the number of visits per day on the previous day of the prediction target period and the previous day of the first period, a total of the past numbers of visits to the store per hour on the previous day of the prediction target period and the previous day of the first period or a vector in which the number of visits per hour is enumerated by one day

The acquisition unit 101 acquires a temperature and a precipitation for each first period from the environment database 121 as environment information in learning. The acquisition unit 101 acquires a temperature and precipitation for a prediction target period as environmental information in prediction.

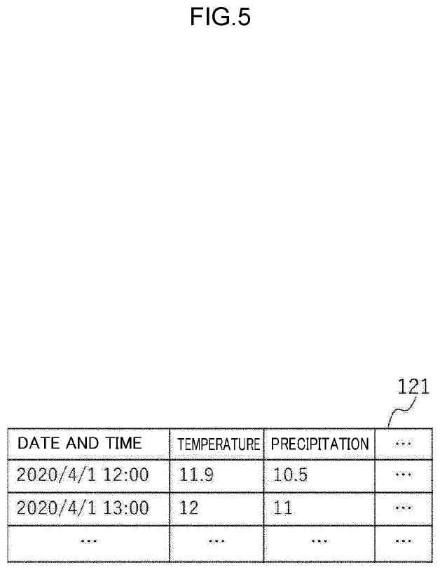

As illustrated in FIG. 5, the environment database 121 is a database in which a temperature and a precipitation around a store are stored every predetermined date and time. In the environment database 121 illustrated in FIG. 5, the temperature and precipitation around the store per hour are stored. In the environment database 121, the temperature and precipitation around the store per day may be stored. The environment database 121 may store information regarding other environments such as humidity and pollen information. In the environment database 121, an actually observed temperature and precipitation are stored in association in the past day. On that day, a temperature and a precipitation based on a forecast of a meteorological agency or the like are stored in association. The acquisition unit 101 may acquire an average value of a temperature and a precipitation per hour for each prediction target period and each first period as a temperature and a precipitation per day for each prediction target period and each first period or may acquire a vector in which the temperature and the precipitation per hour is enumerated for one day.

The acquisition unit 101 acquires, as number-of-sales information in learning, the number of sales of each commodity for the first period from the number-of-sales database 122, and a total of the numbers of sales of all the commodities until the previous day of the first period and the number of sales of each commodity for the plurality of first periods. Hereinafter, a total of the numbers of sales of all the commodities is referred to as a total number of sales. The acquisition unit 101 acquires the total number of sales until the previous day of the prediction target period and the number of sales of each commodity from the number-of-sales database 122 as number-of-sales information in prediction.

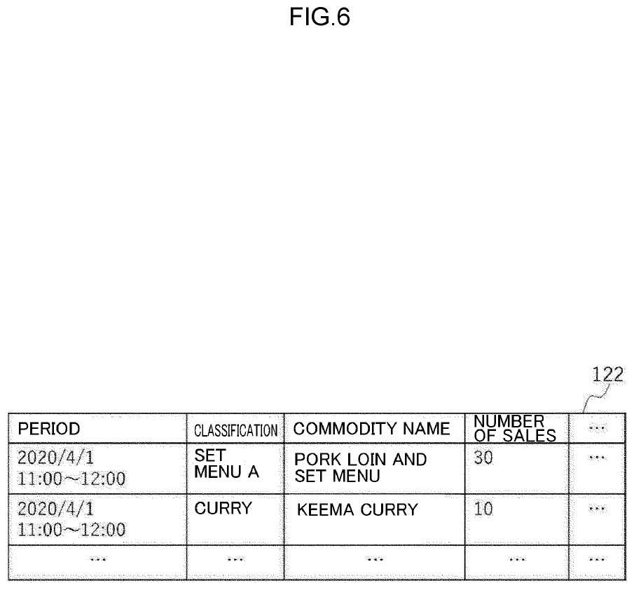

As illustrated in FIG. 6, the number-of-sales database 122 is a database that stores classification of commodities sold for each predetermined period (hereinafter also simply referred to as “classification”), a name (hereinafter also referred to as a “commodity name”), and the number of sales. The acquisition unit 101 may acquire a total of the total number of sales per hour of the previous day of the prediction target period and the previous day of the first period as the total number of sales per day of the previous day of the prediction target period and the previous day of the first period, or may acquire a vector in which the total number of sales per hour is enumerated for one day.

The acquisition unit 101 acquires, as feature information in learning, raw materials used for all the commodities sold for the first period and flag information indicating whether the specific raw materials are used for the commodities from the feature database 123. The acquisition unit 101 acquires, as feature information in prediction, raw materials and flag information to be used for all the commodities scheduled to be sold for the prediction target period from the feature database 123. The acquisition unit 101 converts the acquired raw material into vectors by multi-hot encoding. The acquisition unit 101 may also include the above-described classification of the commodity in the feature information. When the classification is also included in the feature information, the acquisition unit 101 converts the classification into a vector by one-hot encoding.

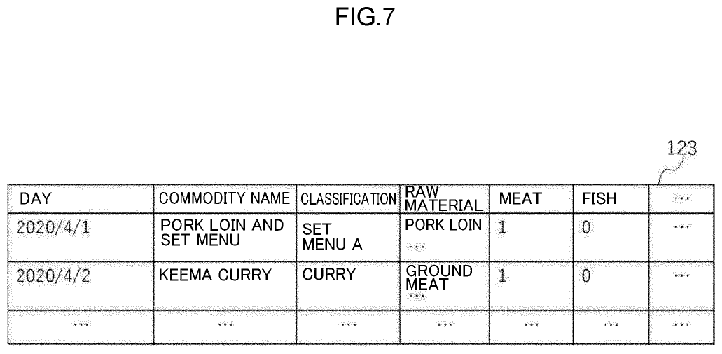

As illustrated in FIG. 7, the feature database 123 stores a commodity name, classification, a raw material, and flag information of the commodity sold on every predetermined day. In the example illustrated in FIG. 7, the flag information is information indicating whether meat or fish is used for a corresponding commodity. In the example illustrated in FIG. 7, “1” is stored as flag information when a specific material is used for the corresponding commodity, and “0” is stored as the flag information when the specific material is not used. In the feature database 123, features related to the commodities such as prices of the commodities sold on the corresponding day or the places of origin may be stored in association.

The acquisition unit 101 exchanges various types of information acquired in learning with the visit learning unit 102 and the ratio learning unit 103, and exchanges various types of information acquired in prediction with the visit prediction unit 104 and the ratio prediction unit 105.

Based on the store number-of-visits information, the environment information, the number-of-sales information, and the feature information, the visit learning unit 102 learns the number-of-visits prediction model 130 for predicting the number of visits to the store for the prediction target period.

Specifically, the visit learning unit 102 learns the number-of-visits prediction model 130 by machine learning by using the number of visits for the first period acquired by the acquisition unit 101 as an objective variable and by using the number of visits and the total number of sales until the previous day of the first period, a temperature and a precipitation of the first period, the raw materials and the flag information converted into the vectors of all the commodities soled for the first period as explanatory variables. The visit learning unit 102 may learn the number-of-visits prediction model 130 by, for example, multiple regression analysis. The visit learning unit 102 stores the learned number-of-visits prediction model 130 in a predetermined storage region.

Based on the number-of-visits information, the environment information, the number-of-sales information and the feature information, the ratio learning unit 103 learns the ratio prediction model 131 for predicting a sales ratio which is a ratio of the number of sales of a commodity to the number of visits.

First, the ratio learning unit 103 calculates the sales ratio of the first period for each commodity by dividing the number of sales of each commodity for the first period acquired by the acquisition unit 101 by the number of visits for the corresponding first period acquired by the acquisition unit 101. Subsequently, the ratio learning unit 103 calculates a simple moving average of the sales ratio using the sales ratio of each commodity including the first period in the latest five business days of the corresponding first period.

Subsequently, the ratio learning unit 103 calculates popularity indicating relative magnitude of the sales ratio for each commodity. Specifically, when a value obtained by dividing the sales ratio of the corresponding commodity for the corresponding first period by a simple moving average of the sales ratio for the corresponding first period is equal to or greater than a first threshold (first threshold >1), the ratio learning unit 103 sets a value (for example, 1) indicating that popularity is relatively high as popularity of the corresponding commodities for the corresponding first period. When the popularity is less than the first threshold, the ratio learning unit 103 sets a value (for example, 0) indicating that the popularity is relatively low as the popularity of the corresponding commodity for the corresponding first period. Then, the ratio learning unit 103 stores the calculated popularity in the popularity database 124. The ratio learning unit 103 may calculate the popularity of each commodity based on a value obtained by dividing the sales ratio of the first period by a weighted moving average or an exponential moving average of the sales ratio of the first period.

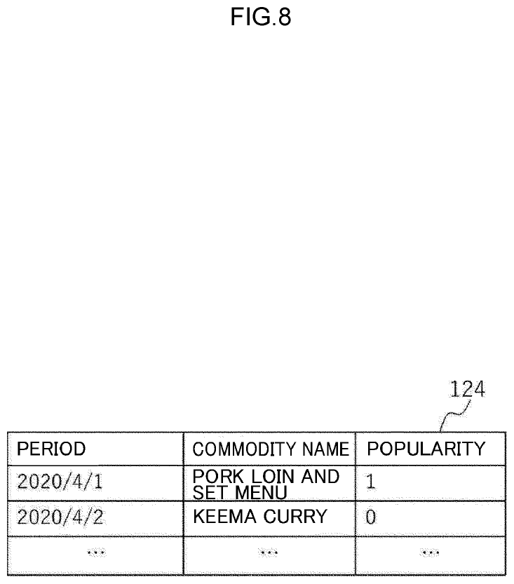

As illustrated in FIG. 8, the popularity database 124 is a database that stores the popularity of commodity for each period (in this case, every day unit corresponding to the first period).

Subsequently, based on the sales ratio, the environment information, and the feature information, the ratio learning unit 103 learns a popularity prediction model for predicting popularity.

Specifically, the ratio learning unit 103 acquires popularity and a period of each commodity from the popularity database 124. Hereinafter, a period corresponding to each commodity is referred to as a popular period. The ratio learning unit 103 acquires a temperature and a precipitation of the popular period from the environment database 121.

In the embodiment, when the oldest day in the popularity period is defined as T1 with regard to each commodity, a day on which the ratio learning unit 103 learns the popularity prediction model is defined as T2, and a period from T1 to T2 is referred to as a second period below.

A day or the like obtained by subtracting a predetermined number of days from T2 may be applied as T1. A latest day or the like in the popularity period may be applied as T2.

The ratio learning unit 103 learns a popularity prediction model by, for example, multiple regression analysis by setting popularity of a corresponding commodity as an objective variable for each commodity using a record in which a popularity period is included in the second period and by setting a temperature and a precipitation for the popularity period as explanatory variables. For example, the ratio learning unit 103 calculates coefficients a₁, a₂, . . . and an intercept using a regression expression expressed in Expression (1) as a popularity prediction model. The ratio learning unit 103 may learn the popularity prediction model using machine learning in conformity with another scheme.

$$\begin{matrix}[ Math . 1 ] & \\ Popularity = {a}_{1} Temperature + {a}_{2} Precipitation + … + Intercept & ( 1 )\end{matrix}$$

The ratio learning unit 103 shortens the second period to relearn the popularity prediction model when the determination coefficient of the learned popularity prediction model is less than a predetermined second threshold. In the embodiment, when the determination coefficient of the popularity prediction model is less than a second threshold, the ratio learning unit 103 adds a predetermined fixed value Tw (for example, one month) to T1 and relearns the popularity prediction model. The ratio learning unit 103 may change T1 so that the number of records related to a corresponding commodity included in the shortened second period decreases by a fixed value to relearn the popularity prediction model.

When the determination coefficient of the popularity prediction model becomes equal to or greater than the second threshold, the ratio learning unit 103 stores the intercept and the coefficients such as a₁, a₂, . . . of the popularity prediction model in the calculated Expression (1), T1, T2, and T1_init which is an initial value of T1 in the popularity factor database 125.

When the popularity prediction model cannot be learned due to a reason such as a small number of corresponding commodities included for the second period, the ratio learning unit 103 learns the popularity prediction model in accordance with the popularity of the corresponding commodities in the latest predetermined number. For example, when a ratio of “1” is equal to or greater than a predetermined threshold in the popularity of the corresponding commodities in the latest predetermined number, the ratio learning unit 103 sets 1 as an intercept of the popularity prediction model of the corresponding commodity and 0 as the coefficient. Further, the oldest day in the popularity of the corresponding commodity is defined as T1, and the day on which the popularity prediction model is learned is defined as T2. The latest day or the like for the popularity period may be applied as T2. On the other hand, when the ratio of “1” is less than the predetermined threshold in the popularity of the corresponding commodity in the latest predetermined number, the ratio learning unit 103 sets 0 as an intercept of the popularity prediction model of the corresponding commodity and sets 0 as the coefficient. Further, the oldest day in the popularity of the corresponding commodity is defined as T1, and the day on which the popularity prediction model is learned is defined as T2. The latest day or the like in the popularity period may be applied as T2.

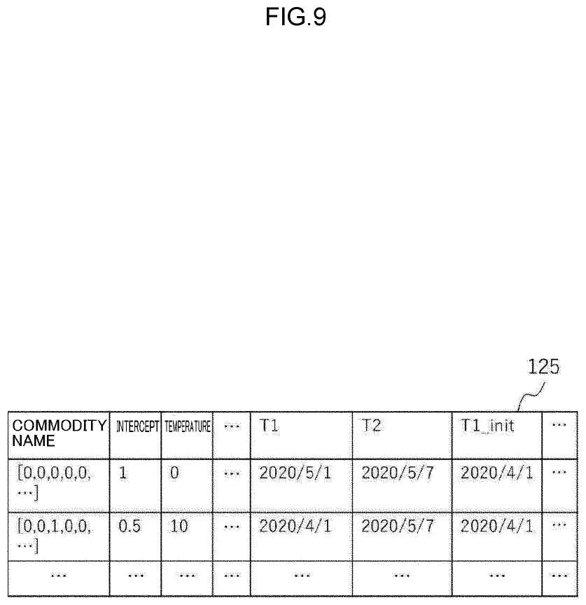

As illustrated in FIG. 9, the popularity factor database 125 stores a commodity name, an intercept of a corresponding popularity prediction model, a coefficient, T1, T2, and T1_init for each commodity. The commodity name is converted into a vector by one-dot encoding and is stored.

Subsequently, the ratio learning unit 103 learns the ratio prediction model 131 based on the sales ratio, the popularity, the environmental information, and the feature information.

Specifically, the ratio learning unit 103 first acquires the vectorized raw material, the flag information, and the popularity prediction model of each commodity for each first period from the feature database 123. The ratio learning unit 103 acquires the popularity of each commodity for each first period from the popularity database 124.

The ratio learning unit 103 learns the ratio prediction model 131 for each commodity by machine learning by using the sales ratio of each commodity for the first period calculated as described above as an objective variable and by using the popularity, the vectorized raw material, and the flag information of each commodity for the corresponding first period, the temperature and the precipitation for the corresponding first period, and the number of sales of the corresponding commodity until the previous day of the corresponding first period as explanatory variables. The ratio learning unit 103 may learn the ratio prediction model 131 by, for example, multiple regression analysis. The ratio learning unit 103 stores the learned ratio prediction model 131 in a predetermined storage region.

The store visit prediction unit 104 predicts the number of visits to the store for a prediction target period based on the number-of-visits prediction model 130, the number-of-visits information, the environment information, the number-of-sales information, and the feature information.

Specifically, the visit prediction unit 104 causes the number-of-visits prediction model 130 learned by the visit learning unit 102 to read the number of visits and the total number of sales until the previous day of the prediction target period acquired by the acquisition unit 101, the temperature and the precipitation of the prediction target period, and the flag information and the raw materials converted into the vectors of all the commodities scheduled to be sold for the prediction target period. The visit prediction unit 104 predicts the number of visits for the prediction target period (hereinafter referred to as a “predicted number of visits”).

The ratio prediction unit 105 predicts a sales ratio for the prediction target period based on the ratio prediction model 131, the number-of-visits information, the environment information, the number-of-sales information and the feature information.

Specifically, the ratio prediction unit 105 first causes the popularity prediction model related to a target commodity which is a target of which the number of sales read from the popularity factor database 125 to read the temperature and the precipitation of the prediction target period acquired by the acquisition unit 101. The ratio prediction unit 105 predicts popularity of the target commodity for the prediction target period (hereinafter referred to as “prediction popularity”)

Subsequently, the ratio prediction unit 105 causes the ratio prediction model 131 of the target commodity for the prediction target period learned by the ratio learning unit 103 to read the prediction popularity, the vectorized raw material and the flag information of the target commodity for the prediction target period, the temperature and the precipitation of the prediction target period, and the number of sales of the target commodity until the previous day of the prediction target period. The ratio prediction unit 105 predicts a sales ratio of the target commodity for the prediction target period (hereinafter referred to as a “predicted sales ratio”)

The sales prediction unit 106 predicts the number of sales of the target commodity based on the predicted number of visits predicted by the visit prediction unit 104 and the predicted sales ratio predicted by the ratio prediction unit 105. Specifically, the sales prediction unit 106 outputs a product of the predicted number of visits and the predicted sales ratio as the predicted number of sales of the target commodity to the output unit 107.

The output unit 107 displays the predicted number of sales of the target commodity predicted by the sales prediction unit 106 on the display unit 16.

Next, an operation of the demand prediction device 10 will be described.

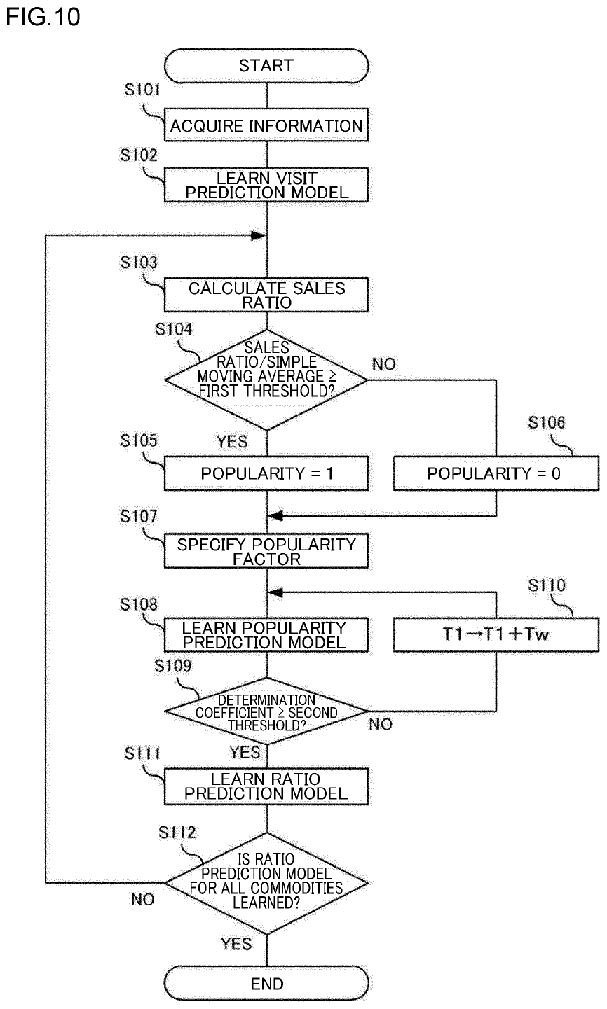

FIG. 10 is a flowchart illustrating a flow of demand learning processing performed by the demand prediction device 10. The CPU 11 reads a demand learning program from the ROM 12 or the storage 14 and loads and execute the demand learning program on the RAM 13 to perform the demand learning process.

In step S101, the CPU 11 serving as an acquisition unit 101 acquires the number of visits, a temperature, a precipitation, and a total number of sales for the first period and the number of visits, a total number of sales, and the number of sales of each commodity until the previous day of the first period. The CPU 11 serving as an acquisition unit 101 acquires raw materials and flag information used for all the commodities sold for the first period.

In step S102, the CPU 11 serving as a visit learning unit 102 learns the number-of-visits prediction model 130 by machine learning by using the number of visits for the first period as an objective variable and by using the number of visits and the total number of sales until the previous day of the first period, the temperature and the precipitation of the first period, and the raw materials and the flag information of all the commodities sold for the first period as explanatory variables.

In step S103, the CPU 11 serving the ratio learning unit 103 calculates a sales ratio for the first period by dividing the number of sales of the commodity for the corresponding first period by the corresponding number of visits number for the first period.

In step S104, the CPU 11 serving as the ratio learning unit 103 determines whether a value obtained by dividing the sales ratio of the corresponding commodity calculated in step S103 by a simple moving average of the sales ratio for the corresponding first period is equal to or greater than the first threshold. When the value obtained by dividing the sales ratio by the simple moving average of the sales ratio is equal to or greater than the first threshold (Yes in step S104), the CPU 11 moves to step S105. Conversely, when the value obtained by dividing the sales ratio by the simple moving average of the sales ratio is less than the first threshold (No in step S104), the CPU 11 moves to step S106.

In step S105, the CPU 11 serving as the ratio learning unit 103 sets 1 as the popularity of the corresponding commodity and stores the popularity in the popularity database 124.

In step S106, the CPU 11 serving as the ratio learning unit 103 sets 0 as the popularity of the commodity and stores the popularity in the popularity database 124.

In step S107, the CPU 11 serving as the ratio learning unit 103 acquires the temperature and the precipitation of the popularity period, and the flag information and the raw material converted into the vector corresponding to the popularity period and the corresponding commodity as popularity factors from the popularity factor database 125.

In step S108, the CPU 11 serving as the ratio learning unit 103 learns the popularity prediction model of the second period by the multiple regression analysis by using the popularity of the corresponding commodity read from the popularity database 124 as an objective variable and by using the temperature and the precipitation of the popularity period as explanatory variables.

In step S109, the CPU 11 serving as the ratio learning unit 103 determines whether the determination coefficient of the popularity prediction model learned in step S108 is equal to or greater than the second threshold. When the determination coefficient of the popularity prediction model is equal to or greater than the second threshold (Yes in step S109), the CPU 11 moves to step S111. Conversely, when the determination coefficient of the popularity prediction model is less than the second threshold (No in step S109), the CPU 11 moves to step S110.

In step S110, the CPU 11 serving as the ratio learning unit 103 shortens the second period and returns to step S109. Specifically, the CPU 11 adds the predetermined fixed value Tw to T1 which is a start time of the second period.

In step S111, the CPU 11 serving as the ratio learning unit 103 learns the ratio prediction model 131 by using the sales ratio of the corresponding commodity for the first period as an objective variable and by using the popularity of the corresponding commodity, the vectorized raw material and flag information, the temperature and the precipitation for the corresponding first period, and the number of sales of the corresponding commodity until the previous day of the corresponding first period as explanatory variables.

In step S112, the CPU 11 serving as the ratio learning unit 103 determines whether the ratio prediction model of all the commodities sold for the first period is learned. When the CPU 11 learns the ratio prediction model of all the commodities sold for the first period (Yes in step S112), the CPU 11 ends the demand learning processing. Conversely, when the ratio prediction model of all the commodities sold for the first period is not learned (No in step S112), the CPU 11 returns to step S103.

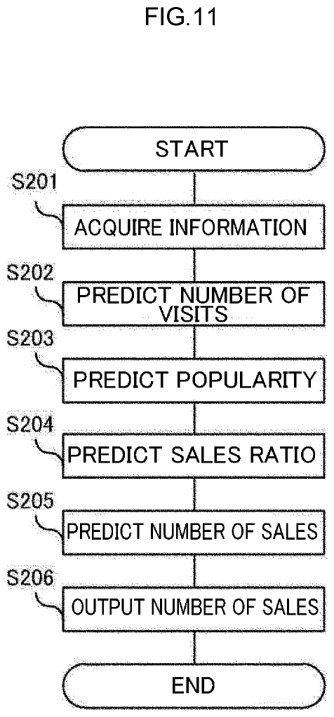

FIG. 11 is a flowchart illustrating a flow of demand prediction processing performed by the demand prediction device 10. The CPU 11 performs the demand prediction processing by reading the demand prediction program from the ROM 12 or the storage 14 and loading and executing the prediction program on the RAM 13.

In step S201, the CPU 11 serving as the acquisition unit 101 acquires the number of visits, the total number of sales, and the number of sales of the target commodity until the previous day of the prediction target period. The CPU 11 serving as the acquisition unit 101 acquires the temperature and the precipitation of the prediction target period and the raw materials and flag information of all the commodities sold for the prediction target period.

In step S202, the CPU 11 serving as the visit prediction unit 104 causes the number-of-visits prediction model 130 of the prediction target period to read the number of visits and the total number of sales on the previous day of the prediction target period, the temperature and precipitation of the prediction target period, and the raw material and the flag information converted into the vectors of all commodities scheduled to be sold for the prediction target period. The visit prediction unit 104 predicts the predicted number of visits.

In step S203, the CPU 11 serving as the ratio prediction unit 105 causes the popularity prediction model of a target commodity for the prediction target period to read the temperature and precipitation of the prediction target period. Then, the CPU 11 predicts the predicted popularity.

In step S204, the CPU 11 serving as the ratio prediction unit 105 causes the ratio prediction model 131 of the target commodity for the prediction target period to read the predicted popularity, the temperature and the precipitation of the prediction target period, the number of sales of the target commodity on the previous day of the prediction target period, and the raw material and the flag information of the target commodity for the prediction target period. The ratio prediction unit 105 predicts a predicted sales ratio.

In step S205, the CPU 11 serving as the sales prediction unit 106 predicts a product of the predicted number of visits and the predicted sales ratio as the predicted number of sales of the target commodity.

In step S206, the CPU 11 serving aa the output unit 107 displays the predicted number of sales of the target commodity on the display unit 16 and ends the demand prediction processing.

As described above, the demand prediction device according to the embodiment acquires factor information regarding a factor influencing the number of sales of a commodity in the store. The demand prediction device predicts the number of visits to the store for a prediction target period based on a number-of-visits prediction model used to predict the number of visits to the store for the prediction target period and learned based on the factor information and number-of-visits information regarding a past number of visits to the store. The demand prediction device predicts the ratio based on a ratio prediction model used to predict the ratio and learned based on the factor information and a ratio of the number of sales of a commodity to the number of visits, and the acquired factor information and the acquired factor information. The demand prediction device predicts the number of sales of the commodity based on the predicted number of visits and the predicted ratio. Thus, it is possible to predict the number of sales of a commodity in the store.

Here, in order to predict the number of sales of each commodity, a method of applying a scheme of predicting the number of visits for each commodity according to the technology of the related art to each commodity, and collecting data related to the same commodity and generating a prediction model for each commodity or for each classification (category) to which the commodity belongs can be considered. However, the sale number of the commodity is strongly influenced by the number of visits, but the number of sales of the commodity is also influenced by popularity of the commodity. That is, the factor for many sold commodities is not limited to a large number of visits. The number of sales of the commodity is sometimes increased because the commodity is popular. Thus, an increase or decrease in the number of sales includes an influence of an increase or decrease in the number of visits and an influence of the presence or absence of popularity for each commodity. As described above, when the technology of the related art for predicting the number of visits is applied to each commodity, it is difficult to distinguish the influence of the number of visits from the influence of the popularity. There is a possibility of prediction accuracy deteriorates when the number of visits increases or decreases. On the other hand, according to the embodiment, by combining the prediction of the number of visits and the prediction of the sales ratio corresponding to the popularity, it is possible to separate the influence of the increase or decrease in the number of visits in prediction of the number of sales as prediction of the number of visits, and thus prediction accuracy of the number of sales is improved.

The demand prediction device according to the embodiment predicts the sales ratio using a model in which a change in popularity over time is taken into consideration in addition to environment information and a feature of a commodity. Therefore, the prediction accuracy of the number of sales predicted using the sales ratio is improved.

Since the demand prediction device according to the embodiment performs learning and prediction using a feature of a raw material or the like which is an element of commodity. For example, even when there is a change in an element of the commodity, such as a case in which the raw materials are partially different in the same menu, prediction can be performed. It is possible to obtain supplementary effects such as utilization of a feature of a commodity with high popularity obtained in a process of predicting the sales ratio for development of a new commodity or the like.

### Modified Example

The present invention is not limited to the above-described embodiment, and various modifications and applications can be made without departing from the scope of the present invention.

For example, the visit learning unit 102 and the ratio learning unit 103 may be configured separately from the demand prediction device 10. In other words, the visit prediction unit 104 may predict the number of visits to the store for the prediction target period based on the number-of-visits prediction model 130 learned by a device configured separately from the demand prediction device 10 and the factor information acquired by the acquisition unit 101. The ratio prediction unit 105 may predict the sales ratio based on the ratio prediction model learned by a device configured separately from the demand prediction device 10 and the factor information acquired by the acquisition unit 101.

In the foregoing embodiment, the case where the ratio learning unit 103 learns a popularity prediction model for each commodity as a popularity prediction model for each commodity has been described. However, a popularity prediction model for each classification to which the commodity belongs or a raw material used for the commodity may be learned as a popularity prediction model for the commodity. For example, when a popularity prediction model for each raw material is learned, the ratio learning unit 103 learns a popularity prediction model for each raw material by using popularity of a commodity related to a corresponding raw material as an objective variable, as in the above embodiment. The ratio prediction unit 105 integrates output results of the popularity prediction model for each corresponding raw material with respect to all the raw materials used for a target commodity for the prediction target period by a weighted average or the like and predicts popularity of the target commodity. The ratio learning unit 103 may learn the popularity prediction model for some or all of the raw materials included in the commodity as a popularity prediction model for each raw material. In this case, the ratio learning unit 103 converts the raw material corresponding to the commodity acquired from the feature database 123 into a vector by multi-hot encoding and adds flag information to the vector to obtain a vector of the raw material. The ratio learning unit 103 may learn the popularity prediction model in the same way as described above using some or all of the vector of the raw material and the popularity of the commodity related to the raw material as objective variables.

The ratio prediction unit 105 may predict the popularity of the target commodity from a popularity prediction model of the target commodity or a commodity or raw material similar to the raw material without being limited to the case in which the popularity of the target commodity is predicted from a popularity prediction model of the target commodity or a commodity, raw material, or the like matching the raw material.

In the foregoing embodiment, the case where environment information and the feature information are used as examples of the factor information has been described, but other factor information may be used. For example, information regarding an event held around a store or scheduled to be held may be used as the factor information.

In the foregoing embodiment, each model may be learned on each day of week to which a day which is a first period belongs. In this case, the number of visits and a sales ratio may be predicted using each model corresponding to a day of week to which a day which is a prediction target period belongs. Accordingly, the number of sales in which a tendency for each day of week is reflected can be predicted.

In the foregoing embodiment, the case in which the number of visits and the number of sales until the previous day of the prediction target period and the first period are used for learning and prediction has been described, but it is not essential to use such information for learning and prediction.

Various processors other than the CPU may execute various types of processing performed by causing the CPU to read software (programs) according to the embodiment. In this case, examples of the processors include dedicated electric circuits which are processors that have circuit configurations designed dedicatedly for execute specific processing, such as a programmable logic device (PLD) of which a circuit configuration can be changed after a field-programmable gate array (FPGA) or the like is manufactured, an application specific integrated circuit (ASIC), or the like. The demand prediction processing may be executed by one of the various processors or may be executed by a combination of two or more of the same type or different types (for example, a plurality of FPGAs or a combination of a CPU, an FPGA, or the like). The hardware structures of these various processors are more specifically electrical circuits in which circuit elements such as semiconductor elements are combined.

In the embodiment, the aspect in which the demand prediction program is stored (installed) in advance in the storage 14 has been described, but the present invention is not limited thereto. The program may be provided in a form stored in a non-transitory storage medium such as a compact disk read only memory (CD-ROM), a digital versatile disk read only memory (DVD-ROM), and a Universal Serial Bus (USB) memory. The program may be downloaded from an external device via a network.

The following supplements are disclosed in relation to the foregoing embodiments

### (Supplement 1)

A demand prediction device including:
a memory, and
at least one processor connected to the memory,
wherein
the processor
acquires factor information regarding a factor influencing the number of sales of a commodity
in a store;
predicts the number of visits to the store for a prediction target period based on a number-of-visits prediction model used to predict the number of visits to the store for the prediction target period and learned based on the factor information and number-of-visits information regarding a past number of visits to the store and the factor information acquired by the acquisition unit;
predicts the ratio based on a ratio prediction model used to predict a ratio of the number of sales of a commodity to the number of visits and learned based on the factor information and the ratio, and the factor information acquired by the acquisition unit; and predicts the number of sales of a commodity based on the number of visits predicted by the visit prediction unit and the ratio predicted by the ratio prediction unit.

### (Supplement 2)

A non-transitory storage medium that stores a program which is able to be executed by a computer to execute demand prediction processing,
wherein the demand prediction processing includes:
acquiring factor information regarding a factor influencing the number of sales of a commodity in a store;
predicting the number of visits to the store for a prediction target period based on a number-of-visits prediction model used to predict the number of visits to the store for the prediction target period and learned based on the factor information and number-of-visits information regarding a past number of visits to the store and the factor information acquired by the acquisition unit;
predicting a ratio of the number of sales of a commodity to the number of visits based on a ratio prediction model used to predict the ratio and learned based on the factor information and the ratio, and the factor information acquired by the acquisition unit; and predicting the number of sales of a commodity based on the number of visits predicted by the visit prediction unit and the ratio predicted by the ratio prediction unit.

### REFERENCE SIGNS LIST

Demand prediction device
11 CPU
12 ROM
13 RAM
14 Storage
16 Display unit
17 Communication I/F
19 Bus
101 Acquisition unit
102 Number-of-visits learning unit
103 Ratio learning unit
104 Number-of-visits prediction unit
105 Ratio prediction unit
106 Sales prediction unit
130 Number-of-visits prediction model
131 Ratio prediction model

1. A demand prediction device comprising:
a memory; and
at least one processor coupled to the memory,
the at least one processor being configured to:
acquire factor information regarding a factor influencing a number of sales of a commodity in a store;
predict a number of visits to the store for a prediction target period based on a number-of-visits prediction model used to predict the number of visits to the store for the prediction target period and learned based on factor information and number-of-visits information regarding a past number of visits to the store, and the acquired factor information;
predict a ratio of the number of sales of the commodity to the number of visits based on a ratio prediction model used to predict the ratio and learned based on the past factor information and the ratio, and the acquired factor information; and
predict the number of sales of the commodity based on the predicted number of visits and the predicted ratio.

2. The demand prediction device according to claim 1, wherein the factor information includes at least one of environment information regarding an external environment around the store or feature information regarding a feature of the commodity.

3. The demand prediction device according to claim 1, wherein the at least one processor acquires the past number-of-visits information, and
wherein the at least one processor predicts the number of visits to the store based on the acquired factor information and the acquired number-of-visits information and the number-of-visits prediction model.

4. The demand prediction device according to claim 1, wherein the at least one processor predicts popularity indicating a relative magnitude of the ratio based on the acquired factor information and a popularity prediction model used to predict the popularity and learned based on the past factor information and the popularity, and predicts the ratio based on the acquired factor information, the predicted popularity, and the ratio prediction model.

5. The demand prediction device according to any claim 1, wherein the at least one processor is further configured to
learn the number-of-visits prediction model based on the number-of-visits information and the factor information; and
calculate the ratio based on the past number-of-visits information and number-of-sales information regarding a past number of sales of the commodity and learn the ratio prediction model based on the past factor information and the calculated ratio.

6. The demand prediction device according to claim 4, wherein the at least one processor is further configured to:
learn the number-of-visits prediction model based on the number-of-visits information and the factor information; and
calculate the ratio based on the number-of-visits information for a predetermined period and number-of-sales information regarding a past number of sales of the commodity, learn the popularity prediction model based on the past factor information and the popularity corresponding to the calculated ratio, shorten the predetermined period when the learned popularity prediction model does not satisfy a predetermined condition, and relearn the popularity prediction model and learn the ratio prediction model based on the calculated ratio, the past factor information, and popularity corresponding to the ratio.

7. A demand prediction method comprising:
acquiring, by an acquisition unit, factor information regarding a factor influencing a number of sales of a commodity in a store;
predicting, by a visit prediction unit, a number of visits to the store for a prediction target period based on a number-of-visits prediction model used to predict the number of visits to the store for the prediction target period and learned based on the factor information and number-of-visits information regarding a past number of visits to the store, and the factor information acquired by the acquisition unit;
predicting, by a ratio prediction unit, a ratio of the number of sales of the commodity to the number of visits based on a ratio prediction model used to predict the ratio and learned based on the past factor information and the ratio, and the factor information acquired by the acquisition unit; and
predicting, by a sales prediction unit, the number of sales of the commodity based on the number of visits predicted by the visit prediction unit and the ratio predicted by the ratio prediction unit.

8. A non-transitory storage medium storing a program executable by a computer so as to execute demand prediction processing, the demand prediction processing including:
acquiring factor information regarding a factor influencing a number of sales of a commodity in a store;
predicting a number of visits to the store for a prediction target period based on a number-of-visits prediction model used to predict the number of visits to the store for the prediction target period and learned based on factor information and number-of-visits information regarding a past number of visits to the store, and the acquired factor information;
predicting a ratio of the number of sales of the commodity to the number of visits based on a ratio prediction model used to predict the ratio and learned based on the past factor information and the ratio, and the acquired factor information; and
predicting the number of sales of the commodity based on the predicted number of visits and the predicted ratio.
